(19) United States
(12) Patent Application Publication
(10) Pub. No.: US 2010/0036845 A1
(43) Pub. Date: Feb. 11, 2010

(54) System and Method for Negotiating the Access Control List of Data Items in an Ad-Hoc Network with Designated Owner Override Ability

(75) Inventors: James Andrew GODFREY, Waterloo (CA); Axel FERRAZZINI, Toronto (CA); Nicholas P. ALFANO, Stratford-Upon-Avon (GB)

Correspondence Address: Research in Motion Corp./CR;Attn: J. Robert Brown, 5601 Granite Parkway, Suite 750, Plano, TX, 75024, US

(73) Assignee: RESEARCH IN MOTION LIMITED, Waterloo (CA)

(21) Appl. No.: 12/188,019

(22) Filed: Aug. 7, 2008

(51) Int. Cl. G06F 17/30

(52) U.S. Cl. 707/9; 707/E17.059

(57) ABSTRACT

A method is disclosed for managing an access control list for a data item. The method includes designating an owner for the access control list, wherein the owner is a member of the access control list, and wherein only the owner of the access control list is allowed to manage the access control list.

### BACKGROUND

The Open Mobile Alliance (OMA) Device Management (DM) specification supports the storage in a virtual DM tree of data items that might be associated with a telecommunications device. Any application, function, agent, or other software or firmware component that might have access to such a data item will be referred to herein as an endpoint. An endpoint might be or might reside in a network or a device that can connect to the network. Multiple endpoints might have permission to access a single data item, and each endpoint might have a different level of access. For example, one endpoint might be allowed to read, write, or delete a data item, another endpoint might be allowed only to read or write the same data item, and yet another endpoint might be allowed only to read the data item.

Each data item typically has an access control list that specifies the level of access possessed by each endpoint that can access the data item. The use of the access control list can prevent the accidental or malicious modification of a device's configuration settings. For example, device users might not reliably configure a device's values or adjust settings to better utilize resources in response to capacity constraints. Access by endpoints to the configuration settings may also need to be controlled since the endpoints might be able to control a device remotely and there may be secure information among the configuration settings (passwords, etc.). The access control list can prevent a user from inadvertently changing a configuration setting or prevent an unauthorized endpoint from gaining access to a data item.

As used herein, the term “device” might in some cases refer to mobile devices such as mobile telephones, personal digital assistants, handheld or laptop computers, and similar devices that have telecommunications capabilities. In other cases, the term “device” might refer to devices that have similar capabilities but that are not transportable, such as fixed line telephones, desktop computers, set-top boxes, or network nodes. The term “device” can also refer to any hardware or software component that can terminate a communication session.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an access control list according to an embodiment of the disclosure.

FIG. 2 is a flow diagram for negotiating an access control list according to an embodiment of the disclosure.

FIG. 3 is a diagram of a wireless communications system including a device operable for some of the various embodiments of the disclosure.

FIG. 4 is a block diagram of a device operable for some of the various embodiments of the disclosure.

FIG. 5 is a diagram of a software environment that may be implemented on a device operable for some of the various embodiments of the disclosure.

FIG. 6 is an illustrative computing system suitable for some of the various embodiments of the disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In an embodiment, a method is disclosed for managing an access control list for a data item. The method includes designating an owner for the access control list, wherein the owner is a member of the access control list, and wherein only the owner of the access control list is allowed to manage the access control list.

In another embodiment, a device is provided that is configured to manage an access control list for a data item. The device includes a processor configured to designate an owner for the access control list, wherein the owner is a member of the access control list, and wherein only the owner of the access control list is allowed to manage the access control list.

Some endpoints might have an ability to change the permission levels that other endpoints have for a data item. For example, an endpoint with administrative rights might be allowed to revoke the access privileges of another endpoint or give another endpoint additional privileges. When multiple endpoints with such an ability have access to the same data item, each might try to override the access privileges of the others. This could lead to ambiguity in determining the access privileges that an endpoint has for a data item. Under the prior art, such ambiguity might be prevented by the application of a coordination procedure among the endpoints. That is, the endpoints might need to communicate with one another and resolve among themselves the access privileges that each will have for the data item.

In an embodiment, such communication and coordination among the endpoints is not needed. Instead, one endpoint might be defined as the owner of an access control list. Only the owner of an access control list is allowed to modify its own access privileges and the access privileges of the other endpoints that are members of the same access control list. Also, only the owner of an access control list can establish a candidate access control list as the access control list that is applied to the data item. In addition, only the owner of an access control list can override an existing access control list with another access control list.

In an embodiment, an endpoint can declare its intention to be the owner of an access control list. If the access control list does not have an owner at the time the endpoint declares this intention, the endpoint becomes the owner of the access control list. If the access control list does have an owner at the time the endpoint declares this intention, the endpoint is not allowed to become the owner of the access control list. An endpoint that declares its intention to be the owner of an access control list and is allowed to become the owner will be referred to herein as the declared owner.

In other cases, as described below, an endpoint that has not declared its intention to become the owner of an access control list might be given temporary “wildcard” ownership privileges so that it can set its access control list as the access control list for a data item. Such an endpoint will be referred to herein as a wildcard owner. A wildcard owner has ownership privileges over an access control list only until it sets its proposed access control list as the access control list that will actually be used for a data item. Its temporary ownership privileges are then revoked, and the access control list has no owner.

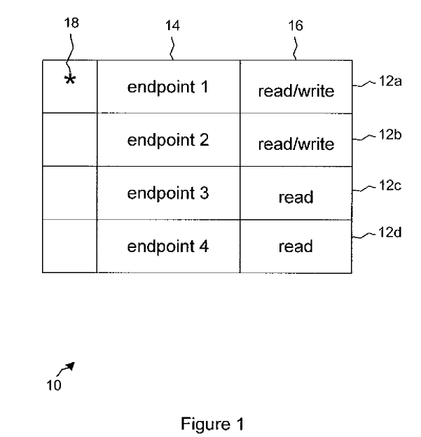

FIG. 1 illustrates an embodiment of an access control list 10. In this example, the access control list 10 includes four entries 12, but in other embodiments, other numbers of entries 12 could be present. Each entry 12 lists a name of an endpoint 14 that has access to the data item associated with the access control list 10. Associated with each endpoint 14 is an access level 16 that has been granted to the endpoint 14. In this example, endpoint 1 in entry 12a and endpoint 2 in entry 12b have been granted both read and write access to the data item to which the access control list 10 pertains. Endpoint 3 in entry 12c and endpoint 4 in entry 12d have been granted read-only access to the data item. In other embodiments, other levels of access could be granted to the endpoints 14.

In an embodiment, the access control list 10 might also include a flag or other indicator 18 that is associated with one of the entries 12. The indicator 18 indicates that the endpoint 14 in the entry 12 in which the indicator 18 is present is the owner of the access control list 10. That is, if one of the endpoints 14 is flagged by the indicator 18, that endpoint 14 can change the access levels granted to the other endpoints 14 in the access control list 10 and perform the other actions that an owner is allowed to perform, as described above. In some cases, the indicator 18 might specify whether the owner is a declared owner or a wildcard owner.

In an embodiment, no more than one endpoint 14 is allowed to be the owner of the access control list 10. In the example of FIG. 1, endpoint 1 in entry 12a is flagged as the owner of the access control list 10, but in other embodiments, another one of the endpoints 14 could be the owner of the access control list 10. Alternatively, the access control list 10 might not have an owner.

In the cases where the access control list 10 does not have an owner, the indicator 18 would not be present. For example, in the case where the temporary ownership privileges of a wildcard owner have been revoked, the access control list 10 would not have an owner, and no indicator 18 would be present in the access control list 10.

In an embodiment, an endpoint that wishes to establish a particular access control list as the access control list that applies to a particular data item might be able to propose an access control list for that data item. Such a proposed access control list will be referred to herein as a candidate access control list. As described below, a candidate access control list may or may not be accepted as the access control list that will be used for a data item. A candidate access control list that is accepted for a data item will be referred to herein as the current access control list for that data item.

In an embodiment, any trusted endpoint is allowed to propose a candidate access control list that it wishes to become the current access control list. An endpoint can become a trusted endpoint through any well known authentication and authorization procedure, such as the use of a user name and password. For example, when a new device is undergoing an initial setup procedure, an endpoint that is being associated with the device might undergo an authentication and authorization procedure that establishes a trust relationship between the endpoint and the device. An endpoint that successfully passes the authentication and authorization procedure would be considered a trusted endpoint and would be allowed to propose candidate access control lists for data items used by the device.

In an embodiment, the first trusted endpoint that proposes a candidate access control list for a data item is allowed to set that access control list as the data item's current access control list. If this first endpoint also declares its intention to be the owner of the access control list, the first endpoint becomes the declared owner of the access control list. If this first endpoint does not declare its intention to be the owner of the access control list, the first endpoint becomes the wildcard owner of the access control list.

When the first endpoint is the declared owner of an access control list, the first endpoint remains the declared owner of the endpoint, even when subsequent endpoints declare their intentions to be the owner of the access control list. The current access control list (that is, the candidate access control list proposed by the first endpoint) remains the access control list that is enforced for the data item.

When the first endpoint is the wildcard owner of an access control list, the first endpoint sets its candidate access control list as the current access control list and then loses its ownership privileges. The current access control list remains the current access control list but it has no owner. Such temporary ownership might be necessary in order for the first endpoint to “bootstrap” its candidate access control list into the status of a current access control list. That is, since only an owner can store an access control list as a current access control list, the first endpoint is given wildcard ownership status to allow it to store its candidate access control list as the current access control list. This bootstrapping might be performed, for example, when a third party endpoint desires read access to a data item but does not wish to perform any other management activities on the access control list. Since such an endpoint does not need ownership status, its temporary ownership is revoked once it has established its candidate access control list as the current access control list.

If the current access control list has no owner, as would be the case when a wildcard owner has its temporary ownership revoked, and if a subsequent endpoint proposes a candidate access control list but does not declare its intention to be the owner of the candidate access control list, the current access control list remains the current access control list and continues to have no owner. If the current access control list has no owner, and if a subsequent endpoint proposes a candidate access control list and also declares its intention to be the owner of the candidate access control list, the candidate access control list becomes the current access control list, and the subsequent endpoint becomes the owner of the current access control list.

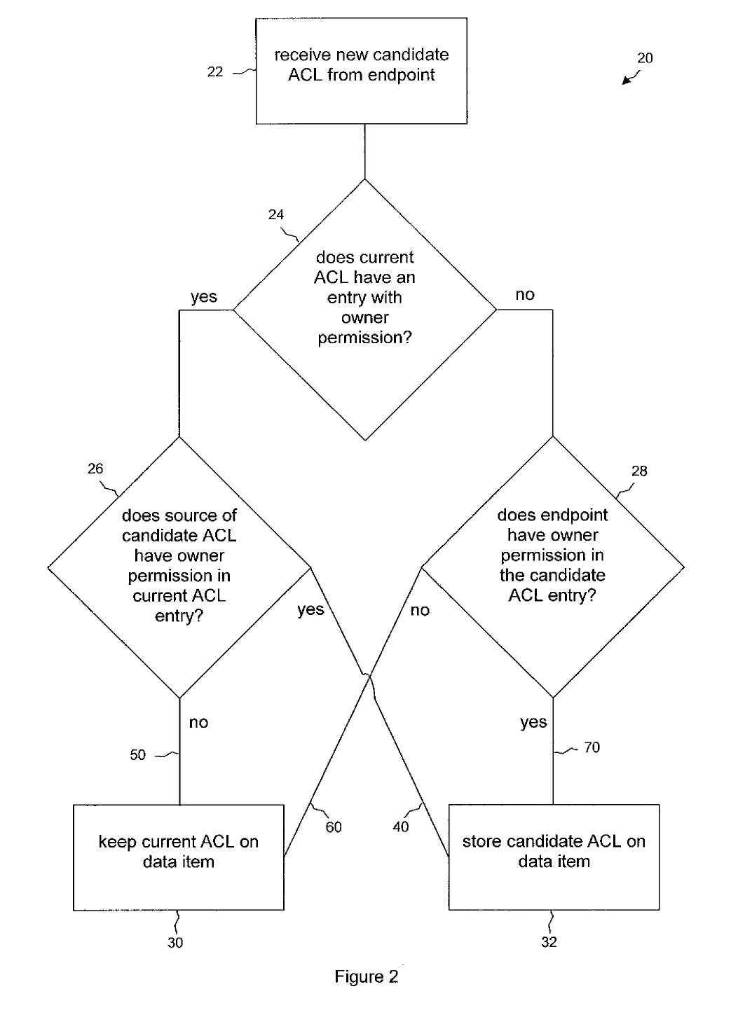

These procedures for determining whether a candidate access control list will become the current access control list and which endpoint, if any, will be the owner of the current access control list are summarized in the flowchart 20 in FIG. 2. At block 22, a new candidate access control list (ACL) is received from an endpoint. It can be assumed at this point that the endpoint is trusted. At block 24, it is determined whether the current ACL has an entry with owner permission. There are at least two cases where the current ACL could have an entry with owner permission. In one case, an endpoint that declared its intention to be the owner of an ACL may have previously passed through the flow 20 and may have become the declared owner of the current ACL.

In another case, the endpoint proposing the candidate ACL might be the first endpoint to propose a candidate ACL. In this case, the endpoint would be designated as a wildcard owner, and the candidate ACL would be designated as a de facto current ACL. That is, a candidate ACL does not become an actual current ACL until block 32 is reached. However, for the purpose of answering the questions in blocks 24 and 26, it can be assumed that a candidate ACL that is the first ACL that is proposed for a data item will eventually be established as a current ACL at block 32. Such a candidate ACL can be considered a de facto current ACL in blocks 24 and 26. Therefore, in the case of a wildcard owner, the de facto current ACL would in fact have an entry with owner permission since it has a wildcard owner in the form of the endpoint that is currently proposing the candidate ACL.

When either of these cases elicits an affirmative answer to the question in block 24, the flow 20 moves to block 26. In block 26, it is determined whether the source of the candidate ACL has owner permission in the current ACL entry. That is, it is determined whether the endpoint that is proposing the candidate ACL is the owner of the current ACL. There are at least two situations where the endpoint that is proposing the candidate ACL can be the owner of the current ACL. In one case, the endpoint is the wildcard owner of the ACL. That is, the endpoint is the first endpoint to propose a candidate ACL but is not declaring an intention to be the owner of the candidate ACL. The candidate ACL is established as a de facto current ACL at that point for the purpose of answering the question in block 26, and so the candidate ACL is one and the same with the current ACL at that point. Therefore, the endpoint that is proposing the candidate ACL is the owner of the current ACL (more specifically, the wildcard owner of the de facto current ACL), and the question in block 26 is answered affirmatively.

In another case where the endpoint that is proposing the candidate ACL can be the owner of the current ACL, the endpoint was previously established as the declared owner of the current ACL. In addition, the endpoint is proposing a candidate ACL to override the current ACL and declares its intention to be the owner of the candidate ACL. In this case, the endpoint that is proposing the candidate ACL would again be the owner of the current ACL and the question in block 26 would again be answered affirmatively.

In an alternative to this case, the endpoint that is proposing the candidate ACL and that is the owner of the current ACL might specify another endpoint that it wishes to become the owner of the candidate ACL. That is, the endpoint flagged in the candidate ACL as the owner of the candidate ACL might be different from the endpoint that is proposing the candidate ACL and that is the owner of the current ACL. Alternatively, the endpoint that is proposing the candidate ACL and that is the owner of the current ACL might specify that the candidate ACL will not have an owner. These alternatives might occur, for example, when a device is being transferred from one carrier to another or when a device is being shut down and it is desired that another endpoint take ownership of the device.

When one of these cases applies in block 26, the flow 20 moves from block 26 to block 32, and the candidate ACL for the data item is stored as the current ACL for the data item. In the case of the wildcard owner, the endpoint would lose its temporary ownership privileges upon its candidate ACL being stored as the current ACL, and the current ACL would not have an entry with owner permission. In the case of the declared owner, the candidate ACL proposed by the endpoint would override the current ACL that the endpoint had previously set, the candidate ACL would be stored as the new current ACL, and the endpoint flagged as the owner of the candidate ACL would become the owner of the new current ACL.

In the case where the endpoint declared its intention to be the owner of the candidate ACL, the endpoint would become the owner of the current ACL. In the case where the endpoint specified another endpoint to be the owner of the candidate ACL, the other endpoint would become the owner of the current ACL. In the case where the endpoint specified that the candidate ACL should not have an owner, the current ACL would not have an owner.

Returning to block 26, there is at least one situation where the endpoint that is proposing the candidate ACL might not be the owner of the current ACL. Specifically, a declared owner might have previously established the current ACL as the current ACL and would therefore be the owner of the current ACL. If the endpoint that is proposing the candidate ACL is different from the endpoint that is the declared owner, the question in block 26 would be answered in the negative, and the flow 20 would proceed to block 30. In this case, the ACL that was established by the previous declared owner would remain the current ACL.

Returning to block 24, if it is determined that the current ACL does not have an entry with owner permission, the flow 20 moves to block 28. The current ACL would not have an entry with owner permission if the current ACL was established as the current ACL by an endpoint that was acting as a wildcard owner. That is, the current ACL has no declared owner, and the temporary ownership privileges of the wildcard owner were revoked after the wildcard owner set the current ACL as the current ACL. Therefore, the current ACL would have no owner, the question in block 24 would be answered in the negative, and the flow 20 would proceed to block 28. Alternatively, the current ACL would not have an entry with owner permission if the previous owner stored an ACL that had no owner.

At block 28, it is determined whether the endpoint has owner permission in the candidate ACL entry. That is, it is determined whether the endpoint that is proposing a candidate ACL is declaring itself to be the owner of the candidate ACL. If the endpoint does not wish to have owner permission on the candidate ACL, the flow 20 moves to block 30, and the current ACL remains the current ACL. For example, an ACL that was previously established by a wildcard owner as the current ACL would retain its current ACL status. If the endpoint does wish to have owner permission on the candidate ACL, the flow 20 moves to block 32, and the candidate ACL is stored as the current ACL. For example, an ACL that was previously established by a wildcard owner as the current ACL would be overridden by the candidate ACL.

Several examples may clarify the manner in which candidate ACLs might pass through the flow 20. In all of these examples, it can be assumed that an endpoint would first have been established as a trusted endpoint in a manner described above and that a candidate ACL proposed by the endpoint would then be received at block 22.

As an example of how a candidate ACL might arrive at block 32 via path 40, an endpoint might be the first endpoint to propose a candidate ACL for a data item and might not declare an intention to be the owner of the candidate ACL. Such an endpoint would then become the wildcard owner of the candidate ACL. The candidate ACL would then become a de facto current ACL for the purpose of answering the question in block 24. The question in block 24 would be answered affirmatively since the de facto current ACL would have an entry with owner permission—namely, the endpoint that has been given temporary, wildcard ownership and is proposing the candidate ACL. The flow would then move to block 26, where it would be determined that the endpoint that proposed the candidate ACL is the owner of the current ACL. This would be the case since the candidate ACL is the de facto current ACL, and the endpoint under consideration has temporary ownership over it. The flow 20 would then follow path 40 to block 32, and the de facto current ACL would become the actual current ACL.

In an alternative manner of arriving at block 32 via path 40, a current ACL might already exist for a data item and might have a declared owner. The endpoint that is the declared owner of the current ACL might wish to replace the current ACL with a candidate ACL and might declare its intention to be the owner of the candidate ACL. In this case, the question in block 24 would be answered affirmatively, since the current ACL would have an entry with owner permission—namely the endpoint under consideration.

The flow would then move to block 26, where it would be determined that the source of the candidate ACL does in fact have owner permission in the current ACL. That is, the endpoint under consideration is the declared owner of the current ACL. Since the question in block 26 would be answered affirmatively, the flow 20 would move along path 40 to block 32, and the candidate ACL would override the current ACL.

As an example of how a candidate ACL might arrive at block 30 via path 50, a current ACL might already exist for a data item and a first endpoint might be the declared owner of the ACL. A second endpoint might then propose a candidate ACL for the same data item. The question in block 24 would be answered affirmatively, since the current ACL would have an entry with owner permission—namely the first endpoint. The flow would then move to block 26, where it would be determined that the source of the candidate ACL does not have owner permission in the current ACL. That is, the second endpoint is not the owner of the current ACL. Since the question in block 26 would be answered negatively, the flow 20 would move along path 50 to block 30, and the current ACL would be retained.

As an example of how a candidate ACL might arrive at block 30 via path 60, the current ACL might have been established by a first endpoint that was acting as a wildcard owner, and so the current ACL would not have an owner. A second endpoint might then propose a candidate ACL but might not declare an intention to be the owner of the candidate ACL. Since the current ACL does not have an owner, the question in block 24 is answered negatively. The flow 20 would then move from block 24 to block 28, where it is determined that the second endpoint does not have owner permission in the candidate ACL, since it did not declare an intention to have such ownership. The flow 20 then moves along path 60 to block 30, and the ACL that was established by the first endpoint remains the current ACL. The current ACL would continue to not have an owner.

As an example of how a candidate ACL might arrive at block 32 via path 70, the current ACL might again have been established by a first endpoint that was acting as a wildcard owner, and so it again would have no owner. A second endpoint might then propose a candidate ACL and might declare an intention to be the owner of the candidate ACL. Since the current ACL does not have an owner, the question in block 24 is again answered negatively, and the flow 20 moves to block 28. It is then determined that the second endpoint does have owner permission in the candidate ACL, since it declared its intention to have ownership over the candidate ACL. Since the question in block 28 is answered affirmatively, the flow 20 moves along path 70 to block 32. The ACL that was established by the first endpoint is overridden, and the candidate ACL proposed by the second endpoint becomes the current ACL.

Further clarification might be gained by examining the different scenarios by which a current ACL is retained, as in block 30, or by which a candidate ACL is stored as the current ACL, as in block 32. At least three scenarios can lead to an ACL being stored as the current ACL. In one case, the first candidate ACL that is proposed for a data item becomes the current ACL for that data item. In another case, if an endpoint that is the owner of a current ACL proposes a candidate ACL to replace the current ACL, the candidate ACL replaces the current ACL. In another case, if a current ACL has no owner and an endpoint proposes a candidate ACL that specifies an owner, the candidate ACL replaces the current ACL.

At least two scenarios can lead to the current ACL being retained as the current ACL. In one case, if an endpoint that is not the owner of a current ACL proposes a candidate ACL to replace the current ACL, the current ACL is retained. In another case, if a current ACL has no owner and an endpoint proposes a candidate ACL that has no owner, the current ACL is retained.

These scenarios might be summarized by a “first in wins” rule. That is, the first candidate ACL for a data item becomes the current ACL for that data item and remains the current ACL for that data item unless the current ACL has no owner and it is overridden by a candidate ACL that does have an owner or unless the current ACL has a declared owner and it is overridden by the declared owner. The first ACL to have a declared owner cannot be overridden by any other ACL.

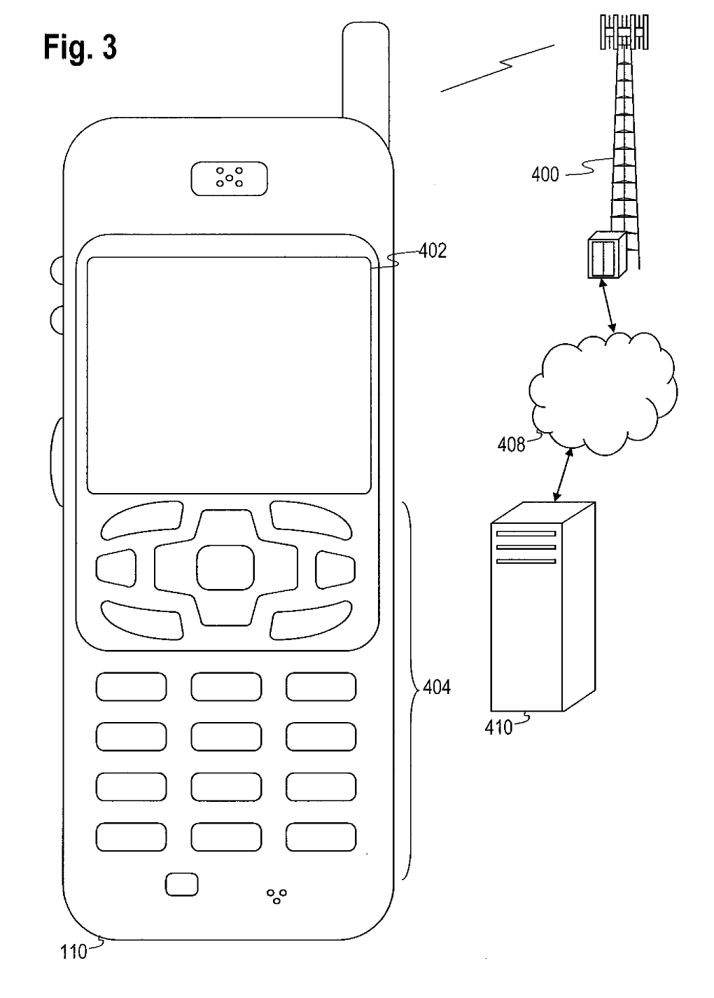

FIG. 3 illustrates a wireless communications system including an embodiment of a typical device 110 that might store and/or manage an access control list as described above. The device 110 is operable for implementing aspects of the disclosure, but the disclosure should not be limited to these implementations. Though illustrated as a mobile phone, the device 110 may take various forms including a wireless handset, a pager, a personal digital assistant (PDA), a portable computer, a tablet computer, or a laptop computer. Many suitable devices combine some or all of these functions. In some embodiments of the disclosure, the device 110 is not a general purpose computing device like a portable, laptop or tablet computer, but rather is a special-purpose communications device such as a mobile phone, wireless handset, pager, or PDA. In another embodiment, the device 110 may be a portable, laptop or other computing device. The device 110 may support specialized activities such as gaming, inventory control, job control, and/or task management functions, and so on.

The device 110 includes a display 402. The device 110 also includes a touch-sensitive surface, a keyboard or other input keys generally referred as 404 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The device 110 may present options for the user to select, controls for the user to actuate, and/or cursors or other indicators for the user to direct. The device 110 may further accept data entry from the user, including numbers to dial or various parameter values for configuring the operation of the device 110. The device 110 may further execute one or more software or firmware applications in response to user commands. These applications may configure the device 110 to perform various customized functions in response to user interaction. Additionally, the device 110 may be programmed and/or configured over-the-air, for example from a wireless base station, a wireless access point, or a peer device 110.

Among the various applications executable by the device 110 are a web browser, which enables the display 402 to show a web page. The web page may be obtained via wireless communications with a wireless network access node, a cell tower, a peer device 110, or any other wireless communication network or system 400. The network 400 is coupled to a wired network 408, such as the Internet. Via the wireless link and the wired network, the device 110 has access to information on various servers, such as a server 410. The server 410 may provide content that may be shown on the display 402. Alternately, the device 110 may access the network 400 through a peer device 110 acting as an intermediary, in a relay type or hop type of connection.

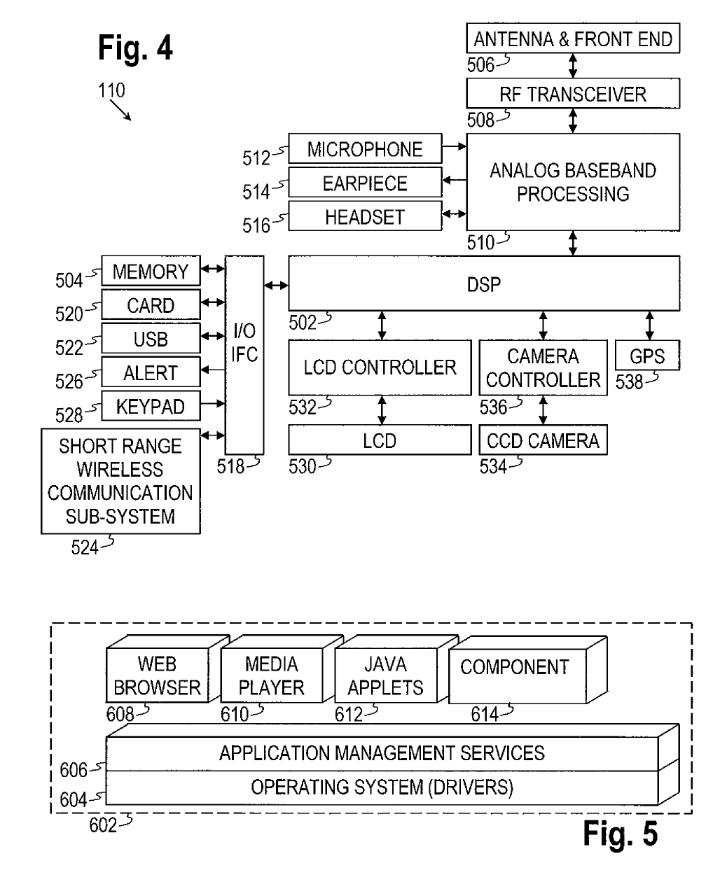

FIG. 4 shows a block diagram of the device 110. While a variety of known components of devices 110 are depicted, in an embodiment a subset of the listed components and/or additional components not listed may be included in the device 110. The device 110 includes a digital signal processor (DSP) 502 and a memory 504. As shown, the device 110 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, a short range wireless communication sub-system 524, an alert 526, a keypad 528, a liquid crystal display (LCD), which may include a touch sensitive surface 530, an LCD controller 532, a charge-coupled device (CCD) camera 534, a camera controller 536, and a global positioning system (GPS) sensor 538. In an embodiment, the device 110 may include another kind of display that does not provide a touch sensitive screen. In an embodiment, the DSP 502 may communicate directly with the memory 504 without passing through the input/output interface 518.

The DSP 502 or some other form of controller or central processing unit operates to control the various components of the device 110 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the device 110 to send and receive information from a cellular network or some other available wireless communications network or from a peer device 110. In an embodiment, the antenna and front end unit 506 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 506 may include antenna tuning and/or impedance matching components, RF power amplifiers, and/or low noise amplifiers.

The RF transceiver 508 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 510 and/or the DSP 502 or other central processing unit. In some embodiments, the RF Transceiver 508, portions of the Antenna and Front End 506, and the analog baseband processing unit 510 may be combined in one or more processing units and/or application specific integrated circuits (ASICs).

The analog baseband processing unit 510 may provide various analog processing of inputs and outputs, for example analog processing of inputs from the microphone 512 and the headset 516 and outputs to the earpiece 514 and the headset 516. To that end, the analog baseband processing unit 510 may have ports for connecting to the built-in microphone 512 and the earpiece speaker 514 that enable the device 110 to be used as a cell phone. The analog baseband processing unit 510 may further include a port for connecting to a headset or other hands-free microphone and speaker configuration. The analog baseband processing unit 510 may provide digital-to-analog conversion in one signal direction and analog-to-digital conversion in the opposing signal direction. In some embodiments, at least some of the functionality of the analog baseband processing unit 510 may be provided by digital processing components, for example by the DSP 502 or by other central processing units.

The DSP 502 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 502 may perform modulation, coding, interleaving, and spreading, and for a receiver function the DSP 502 may perform despreading, deinterleaving, decoding, and demodulation. In another embodiment, for example in an orthogonal frequency division multiplex access (OFDMA) technology application, for the transmitter function the DSP 502 may perform modulation, coding, interleaving, inverse fast Fourier transforming, and cyclic prefix appending, and for a receiver function the DSP 502 may perform cyclic prefix removal, fast Fourier transforming, deinterleaving, decoding, and demodulation. In other wireless technology applications, yet other signal processing functions and combinations of signal processing functions may be performed by the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the short range wireless communication sub-system 524. The USB interface 522 may be used to charge the device 110 and may also enable the device 110 to function as a peripheral device to exchange information with a personal computer or other computer system. The short range wireless communication sub-system 524 may include an infrared port, a Bluetooth interface, an IEEE 802.11 compliant wireless interface, or any other short range wireless communication sub-system, which may enable the device 110 to communicate wirelessly with other nearby devices and/or wireless base stations.

The input/output interface 518 may further connect the DSP 502 to the alert 526 that, when triggered, causes the device 110 to provide a notice to the user, for example, by ringing, playing a melody, or vibrating. The alert 526 may serve as a mechanism for alerting the user to any of various events such as an incoming call, a new text message, and an appointment reminder by silently vibrating, or by playing a specific pre-assigned melody for a particular caller.

The keypad 528 couples to the DSP 502 via the interface 518 to provide one mechanism for the user to make selections, enter information, and otherwise provide input to the device 110. The keyboard 528 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 530, which may include touch screen capability and also display text and/or graphics to the user. The LCD controller 532 couples the DSP 502 to the LCD 530.

The CCD camera 534, if equipped, enables the device 110 to take digital pictures. The DSP 502 communicates with the CCD camera 534 via the camera controller 536. In another embodiment, a camera operating according to a technology other than Charge Coupled Device cameras may be employed. The GPS sensor 538 is coupled to the DSP 502 to decode global positioning system signals, thereby enabling the device 110 to determine its position. Various other peripherals may also be included to provide additional functions, e.g., radio and television reception.

FIG. 5 illustrates a software environment 602 that may be implemented by the DSP 502. The DSP 502 executes operating system drivers 604 that provide a platform from which the rest of the software operates. The operating system drivers 604 provide drivers for the node hardware with standardized interfaces that are accessible to application software. The operating system drivers 604 include application management services (“AMS”) 606 that transfer control between applications running on the device 110. Also shown in FIG. 5 are a web browser application 608, a media player application 610, and Java applets 612. The web browser application 608 configures the device 110 to operate as a web browser, allowing a user to enter information into forms and select links to retrieve and view web pages. The media player application 610 configures the device 110 to retrieve and play audio or audiovisual media. The Java applets 612 configure the device 110 to provide games, utilities, and other functionality. A component 614 might perform functions related to access control lists.

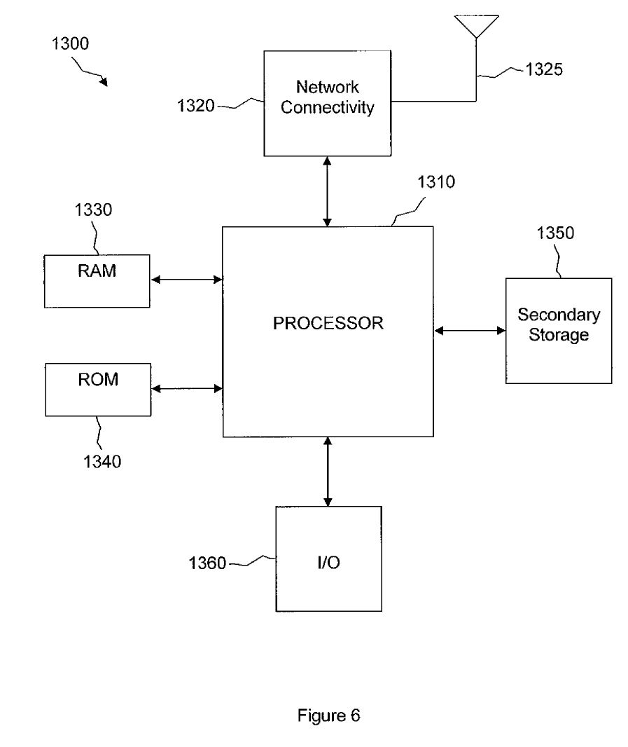

The device 110 and other components described above might include a processing component that is capable of executing instructions related to the actions described above. FIG. 6 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) and/or global system for mobile communications (GSM) radio transceiver devices, and other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1325 might be considered to be a component of the I/O devices 1360 instead of or in addition to being a component of the network connectivity devices 1320. Some or all of the I/O devices 1360 may be substantially similar to various components depicted in the previously described drawing of the device 110, such as the display 402 and the input 404.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for managing an access control list for a data item, comprising:
designating an owner for the access control list, wherein the owner is a member of the access control list, and wherein only the owner of the access control list is allowed to manage the access control list.

2. The method of claim 1, wherein managing the access control list comprises at least one of:
modifying an access privilege of the owner with respect to the data item;
modifying an access privilege of another member of the access control list with respect to the data item;
establishing a candidate access control list as the access control list that is applied to the data item; and
overriding an existing access control list for the data item.

3. The method of claim 2, wherein a first endpoint to propose the candidate access control list becomes a temporary owner of the access control list, and the candidate access control list becomes the access control list for the data item.

4. The method of claim 3, wherein, if the first endpoint did not declare an intention to be the owner of the access control list, the first endpoint's status as a temporary owner is revoked after the candidate access control list becomes the access control list for the data item, the access control list has no owner, and a second endpoint can replace the access control list with another access control list and can specify another owner of the other access control list.

5. The method of claim 4, wherein specifying another owner of the other access control list comprises one of:
the second endpoint specifying itself as owner of the other access control list; and
the second endpoint specifying a third endpoint as owner of the other access control list.

6. The method of claim 3, wherein, if the first endpoint declared an intention to be the owner of the access control list, the first endpoint remains the owner of the access control list, and another endpoint cannot replace the access control list and cannot become the owner of the access control list.

7. A device configured to manage an access control list for a data item, comprising:
a processor configured to designate an owner for the access control list, wherein the owner is a member of the access control list, and wherein only the owner of the access control list is allowed to manage the access control list.

8. The device of claim 7, wherein managing the access control list comprises at least one of:
modifying an access privilege of the owner with respect to the data item;
modifying an access privilege of another member of the access control list with respect to the data item;
establishing a candidate access control list as the access control list that is applied to the data item; and
overriding an existing access control list for the data item.

9. The device of claim 8, wherein a first endpoint to propose the candidate access control list becomes the owner of the access control list, and the candidate access control list becomes the access control list for the data item.

10. The device of claim 9, wherein, if the first endpoint did not declare an intention to be the owner of the access control list, the first endpoint's status as a temporary owner is revoked after the candidate access control list becomes the access control list for the data item, the access control list has no owner, and a second endpoint can replace the access control list with another access control list and can specify another owner of the other access control list.

11. The device of claim 10, wherein specifying another owner of the other access control list comprises one of:
the second endpoint specifying itself as owner of the other access control list; and
the second endpoint specifying a third endpoint as owner of the other access control list.

12. The device of claim 9, wherein, if the first endpoint declared an intention to be the owner of the access control list, the first endpoint remains the owner of the access control list, and another endpoint cannot replace the access control list and cannot become the owner of the access control list.
